(19) United States
(12) Patent Application Publication
(10) Pub. No.: US 2021/0063227 A1
(43) Pub. Date: Mar. 4, 2021

(54) OPERATING LIQUID CONTAINER COMPRISING A BUILT-IN SYSTEM FOR DETECTING THE FILLING LEVEL

(71) Applicant: KAUTEX TEXTRON GmbH & Co. KG, Bonn (DE)

(72) Inventors: Karl-Ludwig Krieger, Brinkum (DE); Jakob Happel, Soldau (DE); Hartmut Wolf, Konigswinter (DE)

(21) Appl. No.: 16/958,554

(22) PCT Filed: Dec. 13, 2018
(86) PCT No.: PCT/EP2018/084747

§ 371 Date: Jun. 26, 2020

(30) Foreign Application Priority Data
Dec. 28, 2017 (DE) 10 2017 223 855.0

(51) Int. Cl. G01F 23/26

(52) U.S. Cl. CPC G01F 23/268; G01F 23/265

(57) ABSTRACT

An operating liquid container defined by a covering wall, a bottom wall, and a side wall connecting the bottom wall to the covering wall. The container includes a reference capacitor including a first electrode and a second electrode, which extend parallel to the bottom wall. A measuring capacitor includes a first electrode and a second electrode, which both extend parallel to the side wall and extend lengthwise towards the covering wall. An evaluation device electrically connected to the reference capacitor and the measuring capacitor, for determining a filling level of the operating liquid container by means of measuring signals determined by the reference capacitor and the measuring capacitor. The operating liquid container includes the first electrode and the second electrode of the reference capacitor are embedded in the bottom wall. The first electrode and the second electrode of the measuring capacitor are embedded in the side wall.

The present invention relates to an operating liquid container having a measuring system for determining a filling level of the operating liquid container.

In the following, reference shall also be made to operating liquid containers designed as urea containers which are designed for use in a motor vehicle. Operating liquid containers according to the invention are, particularly but not exclusively, urea containers for motor vehicles, water containers for storing water to be injected into combustion chambers of an internal combustion engine, windshield washer fluid containers, fuel tanks (for gasolines or diesel fuels), oil containers, additional liquid containers, or additive containers for motor vehicles. Containers of the initially described type are frequently produced using extrusion blow molding, wherein HDPE (high density polyethylene) is particularly suitable for producing extrusion blow molded containers. It is further M possible to produce respective operating liquid containers by means of an injection molding process.

From the prior art, operating liquid containers are known, the filling levels of which are determined by means of lever-type senders which each have a floating body floating on the operating liquid. Corresponding lever-type senders are interference-prone, particularly when they are used in operating liquid containers designed for receiving an aqueous solution. For example, an aqueous urea solution, which is injected for denitrifying exhaust gases in the exhaust gas system, freezes at a temperature below −11° C. As a result, ice chunks can collide with and damage the lever-type sender during vehicle operation.

In order to solve this problem, capacitive filling level sensors are known from the prior art, with which the filling level of an operating liquid container can be determined in a contactless manner by means of capacitors. For example, DE 10 2010 011 638 A1 describes a capacitive filling level sensor having a first and a second elongated level electrode which are arranged parallel to one another on an outer face of a liquid container in a first direction, in which a filling level of the liquid container changes. The filling level sensor further comprises a first and a second elongated reference electrode, which are arranged parallel to one another on the outer face of the liquid container in a second direction, wherein the second direction runs along a bottom of the liquid container. The capacitive filling level sensor described in DE 10 2010 011 638 A1 further comprises an evaluator which is connected to the two level electrodes and the two reference electrodes, and which is designed to determine a filling level of a liquid in an inner space of a liquid container by means of signals from the level electrodes.

The problem addressed by the present invention is that of providing an operating liquid container with a filling level detection system that has improved accuracy with regard to the determination of the filling level of the operating liquid container.

The problem addressed by the present invention is solved by an operating liquid container with the features of claim 1. Advantageous embodiments of the operating liquid container are described in the claims dependent on claim 1.

More precisely, the problem addressed by the present invention is solved by an operating liquid container, the inner space of which is defined by a covering wall, a bottom wall and a side wall connecting the bottom wall to the covering wall, wherein the operating liquid container comprises a reference capacitor comprising a first electrode and a second electrode, which both extend parallel to the bottom wall. The operating liquid container further comprises a measuring capacitor comprising a first electrode and a second electrode, which both have a length extension, a width extension and a depth extension, and both extend parallel to the side wall in such a way that the length extensions of the first electrode and the second electrode extend from the bottom wall towards the covering wall. The operating liquid container further comprises an evaluation device electrically connecting to the reference capacitor and the measuring capacitor, for determining a filling level of the operating liquid container by means of measuring signals determined by the reference capacitor and the measuring capacitor. The operating liquid container according to the invention is characterized in that the first electrode and the second electrode of the reference capacitor are embedded in the bottom wall, and the first electrode and the second electrode of the measuring capacitor are embedded in the side wall.

The operating liquid container according to the invention has an increased determination accuracy with regard to the determination of its filling level because, due to the embedding of the reference capacitor in the bottom wall of the operating liquid container, the first electrode and the second electrode of the reference capacitor have a reduced distance to the inner space of the operating liquid container and thus to the operating liquid located in the inner space of the operating liquid container. Therefore, an electric field located between the first electrode and the second electrode of the reference capacitor interacts less with the material of the bottom wall and more with the operating liquid located in the inner space of the operating liquid container. Since the reference capacitor is in close proximity to the operating liquid at any time during operation, the measured capacitance of the reference capacitor is not dependent on the filling level. As a result, at known electrode geometry, the dielectric conductivity of the operating liquid in the inner space of the operating liquid container can be determined directly from the capacitance of the reference capacitor because the reference capacitor is designed to determine the dielectric conductivity of the operating liquid located in the inner space of the operating liquid container.

The thus determined dielectric conductivity of the operating liquid is used by the evaluation device for determining the filling level from the capacitance of the measuring capacitor. The capacitance of the measuring capacitor also depends on the dielectric conductivity of the medium, in which the electric field spreads between the first electrode and the second electrode of the measuring capacitor. If the dielectric conductivity of the operating liquid is determined with high accuracy, the filling level can therefore be determined with increased accuracy from the capacitance of the measuring capacitor. The capacitance of the measuring capacitor further depends on the filling level of the operating liquid container. Because, the higher the filling level, the more operating liquid is penetrated by the electric field between the first electrode and the second electrode of the measuring capacitor.

Since the first electrode and the second electrode of the measuring capacitor are also embedded in the side wall of the operating liquid container, the influence of the material of the side wall on the capacitance of the measuring capacitor is reduced, and the influence of the operating liquid in the inner space of the operating liquid container on the capacitance of the measuring capacitor is increased. Therefore, the filling level of the operating liquid container can be determined with increased accuracy. Due to the embedding of the reference capacitor in the bottom wall, it is enclosed by the bottom wall. Due to the embedding of the measuring capacitor in the side wall, it is enclosed by the side wall.

A further advantage of embedding the reference capacitor in the bottom wall and the measuring capacitor in the side wall is that both the reference capacitor and the measuring capacitor are mechanically and chemically protected, so that the operating liquid container according to the invention has an increased long-term stability.

The first and the second electrodes of the reference capacitor are arranged opposite of one another such that the side edges extending along their depth extension face one another. The first and the second electrodes of the measuring capacitor are also arranged opposite of one another such that the side edges extending along their depth extension face one another.

The operating liquid container is particularly designed as an operating liquid container for a motor vehicle.

The side wall is preferably designed so as to be continuous.

The dielectric conductivity of the operating liquid can also be called the permittivity of the operating liquid.

The evaluation device is designed as an electronic evaluation device.

Since the capacitance of the reference capacitor also depends on the dielectric conductivity of the operating liquid in the inner space of the operating liquid container, the evaluation device is designed to determine the dielectric conductivity of the operating liquid by means of the reference capacitor.

Preferably, the operating liquid container is designed such that the bottom wall has an elevation extending into the inner space of the operating liquid container, wherein the first electrode and the second electrode of the reference capacitor are embedded in the elevation.

Due to a corresponding design of the operating liquid container, the determination of the dielectric conductivity of the operating liquid is made possible with additionally increased accuracy because possible deposits in the area of the bottom wall have a reduced influence on determining the dielectric conductivity of the operating liquid located in the inner space of the operating liquid container.

The elevation of the bottom wall is preferably designed as a turned-in portion in the inner space of the operating liquid container.

The elevation is raised preferably between 2 mm and 10 mm from the surrounding inner surface of the bottom wall. Further preferably, the elevation is raised between 3 mm and 8 mm from the surrounding inner surface of the bottom wall.

Further preferably, the operating liquid container is designed such that at least one of the first and second electrodes of the measuring capacitor has an uneven width extension along its length extension.

The correspondingly designed operating liquid container has the advantage that the measurement accuracy of the filling level by means of the measuring capacitor can be increased in the areas of the operating liquid container, in which high accuracy is important. The wider the electrodes, the deeper the electric field penetrates the inner space of the operating liquid container and the operating liquid located therein, so that the operating liquid has a greater influence on the capacitance of the measuring capacitor.

The problem addressed by the present invention is solved by an operating liquid container with the features of claim 4. Advantageous embodiments of the operating liquid container are described in the claims dependent on claim 4.

More precisely, the problem addressed by the present invention is solved by an operating liquid container, the inner space of which is defined by a covering wall, a bottom wall and a side wall connecting the bottom wall to the covering wall, wherein the operating liquid container comprises a reference capacitor comprising a first electrode and a second electrode, which both extend parallel to the bottom wall. The operating liquid container further comprises a measuring capacitor comprising a first electrode and a second electrode, which both have a length extension, a width extension and a depth extension, and both extend parallel to the side wall in such a way that the length extensions of the first electrode and the second electrode extend from the bottom wall towards the covering wall. The operating liquid container further comprises an evaluation device electrically connecting to the reference capacitor and the measuring capacitor, for determining a filling level of the operating liquid container by means of measuring signals determined by the reference capacitor and the measuring capacitor. The operating liquid container according to the invention is characterized in that the bottom wall has an extension which extends into the inner space of the operating liquid container, wherein the first electrode and the second electrode of the reference capacitor are fastened to the bottom wall in the area of its elevation.

The operating liquid container according to the invention has an increased determination accuracy with regard to the determination of its filling level because possible deposits in the area of the bottom wall have a reduced influence on determining the dielectric conductivity of the operating liquid located in the inner space of the operating liquid container.

Since the reference capacitor is in close proximity to the operating liquid at any time during operation, the measured capacitance of the reference capacitor is not dependent on the filling level. As a result, at known electrode geometry, the dielectric conductivity of the operating liquid in the inner space of the operating liquid container can be determined directly from the capacitance of the reference capacitor because the reference capacitor is designed to determine the dielectric conductivity of the operating liquid located in the inner space of the operating liquid container.

The thus determined dielectric conductivity of the operating liquid is used by the evaluation device for determining the filling level from the capacitance of the measuring capacitor. The capacitance of the measuring capacitor also depends on the dielectric conductivity of the medium, in which the electric field spreads between the first electrode and the second electrode of the measuring capacitor. If the dielectric conductivity of the operating liquid is determined with high accuracy, the filling level can therefore be determined with increased accuracy from the capacitance of the measuring capacitor. The capacitance of the measuring capacitor further depends on the filling level of the operating liquid container. Because, the higher the filling level, the more operating liquid is penetrated by the electric field between the first electrode and the second electrode of the measuring capacitor.

The first and the second electrodes of the reference capacitor are arranged opposite of one another such that the side edges extending along their depth extension face one another. The first and the second electrodes of the measuring capacitor are also arranged opposite of one another such that the side edges extending along their depth extension face one another.

The elevation of the bottom wall is preferably designed as a turned-in portion in the inner space of the operating liquid container.

The elevation is raised preferably between 2 mm and 10 mm from the surrounding inner surface of the bottom wall. Further preferably, the elevation is raised between 3 mm and 8 mm from the surrounding inner surface of the bottom wall.

The reference capacitor is preferably fastened to the outer face of the bottom wall. The measuring capacitor is preferably fastened to the outer face of the side wall.

The operating liquid container is particularly designed as an operating liquid container for a motor vehicle.

The side wall is preferably designed so as to be continuous.

The dielectric conductivity of the operating liquid can also be called the permittivity of the operating liquid.

The evaluation device is designed as an electronic evaluation device.

Since the capacitance of the reference capacitor also depends on the dielectric conductivity of the operating liquid in the inner space of the operating liquid container, the evaluation device is designed to determine the dielectric conductivity of the operating liquid by means of the reference capacitor.

Further preferably, the operating liquid container is designed such that at least one of the first and second electrodes of the measuring capacitor has an uneven width extension along its length extension.

The correspondingly designed operating liquid container has the advantage that the measurement accuracy of the filling level by means of the measuring capacitor can be increased in the areas of the operating liquid container, in which high accuracy is important. The wider the electrodes, the deeper the electric field penetrates the inner space of the operating liquid container and the operating liquid located therein, so that the operating liquid has a greater influence on the capacitance of the measuring capacitor.

Further preferably, the operating liquid container is designed such that the first electrode and the second electrode of the reference capacitor are embedded in the bottom wall, and the first electrode and the second electrode of the measuring capacitor are embedded in the side wall.

The correspondingly designed operating liquid container has an increased determination accuracy with regard to the determination of its filling level because, due to the embedding of the reference capacitor in the bottom wall of the operating liquid container, the first electrode and the second electrode of the reference capacitor have a reduced distance to the inner space of the operating liquid container and thus to the operating liquid located in the inner space of the operating liquid container. Therefore, an electric field located between the first electrode and the second electrode of the reference capacitor interacts less with the material of the bottom wall and more with the operating liquid located in the inner space of the operating liquid container.

Since the first electrode and the second electrode of the measuring capacitor are also embedded in the side wall of the operating liquid container, the influence of the material of the side wall on the capacitance of the measuring capacitor is reduced, and the influence of the operating liquid in the inner space of the operating liquid container on the capacitance of the measuring capacitor is increased. Therefore, the filling level of the operating liquid container can be determined with increased accuracy. Due to the embedding of the reference capacitor in the bottom wall, it is enclosed by the bottom wall. Due to the embedding of the measuring capacitor in the side wall, it is enclosed by the side wall.

A further advantage of embedding the reference capacitor in the bottom wall and the measuring capacitor in the side wall is that both the reference capacitor and the measuring capacitor are mechanically and chemically protected, so that the operating liquid container according to the invention has an increased long-term stability.

The problem addressed by the present invention is solved by an operating liquid container with the features of claim 7. Advantageous embodiments of the operating liquid container are described in the claims dependent on claim 7.

More precisely, the problem addressed by the present invention is solved by an operating liquid container, the inner space of which is defined by a covering wall, a bottom wall and a side wall connecting the bottom wall to the covering wall, wherein the operating liquid container comprises a reference capacitor comprising a first electrode and a second electrode, which both extend parallel to the bottom wall. The operating liquid container further comprises a measuring capacitor comprising a first electrode and a second electrode, which both have a length extension, a width extension and a depth extension, and both extend parallel to the side wall in such a way that the length extensions of the first electrode and the second electrode extend from the bottom wall towards the covering wall. The operating liquid container further comprises an evaluation device electrically connecting to the reference capacitor and the measuring capacitor, for determining a filling level of the operating liquid container by means of measuring signals determined by the reference capacitor and the measuring capacitor. The operating liquid container according to the invention is characterized in that at least one of the first and second electrodes of the measuring capacitor has an uneven width extension along its length extension.

The correspondingly designed operating liquid container has the advantage that the measurement accuracy of the filling level by means of the measuring capacitor can be increased in the areas of the operating liquid container, in which high accuracy is important. The wider the electrodes, the deeper the electric field penetrates the inner space of the operating liquid container and the operating liquid located therein, so that the operating liquid has a greater influence on the capacitance of the measuring capacitor.

Since the reference capacitor is in close proximity to the operating liquid at any time during operation, the measured capacitance of the reference capacitor is not dependent on the filling level. As a result, at known electrode geometry, the dielectric conductivity of the operating liquid in the inner space of the operating liquid container can be determined directly from the capacitance of the reference capacitor because the reference capacitor is designed to determine the dielectric conductivity of the operating liquid located in the inner space of the operating liquid container.

The thus determined dielectric conductivity of the operating liquid is used by the evaluation device for determining the filling level from the capacitance of the measuring capacitor. The capacitance of the measuring capacitor also depends on the dielectric conductivity of the medium, in which the electric field spreads between the first electrode and the second electrode of the measuring capacitor. If the dielectric conductivity of the operating liquid is determined with high accuracy, the filling level can therefore be determined with increased accuracy from the capacitance of the measuring capacitor. The capacitance of the measuring capacitor further depends on the filling level of the operating liquid container. Because, the higher the filling level, the more operating liquid is penetrated by the electric field between the first electrode and the second electrode of the measuring capacitor.

The first and the second electrodes of the reference capacitor are arranged opposite of one another such that the side edges extending along their depth extension face one another. The first and the second electrodes of the measuring capacitor are also arranged opposite of one another such that the side edges extending along their depth extension face one another.

The reference capacitor is preferably fastened to the outer face of the bottom wall. The measuring capacitor is preferably fastened to the outer face of the side wall.

The operating liquid container is particularly designed as an operating liquid container for a motor vehicle.

The side wall is preferably designed so as to be continuous.

The dielectric conductivity of the operating liquid can also be called the permittivity of the operating liquid.

The evaluation device is designed as an electronic evaluation device.

Since the capacitance of the reference capacitor also depends on the dielectric conductivity of the operating liquid in the inner space of the operating liquid container, the evaluation device is designed to determine the dielectric conductivity of the operating liquid by means of the reference capacitor.

Preferably, the operating liquid container is designed such that the bottom wall has an elevation extending into the inner space of the operating liquid container, wherein the first electrode and the second electrode of the reference capacitor are embedded in the elevation.

The operating liquid container according to the invention has an increased determination accuracy with regard to the determination of its filling level because possible deposits in the area of the bottom wall have a reduced influence on determining the dielectric conductivity of the operating liquid located in the inner space of the operating liquid container.

The elevation of the bottom wall is preferably designed as a turned-in portion in the inner space of the operating liquid container.

The elevation is raised preferably between 2 mm and 10 mm from the surrounding inner surface of the bottom wall. Further preferably, the elevation is raised between 3 mm and 8 mm from the surrounding inner surface of the bottom wall.

Further preferably, the operating liquid container is designed such that the first electrode and the second electrode of the reference capacitor are embedded in the bottom wall, and the first electrode and the second electrode of the measuring capacitor are embedded in the side wall.

The correspondingly designed operating liquid container has an increased determination accuracy with regard to the determination of its filling level because, due to the embedding of the reference capacitor in the bottom wall of the operating liquid container, the first electrode and the second electrode of the reference capacitor have a reduced distance to the inner space of the operating liquid container and thus to the operating liquid located in the inner space of the operating liquid container. Therefore, an electric field located between the first electrode and the second electrode of the reference capacitor interacts less with the material of the bottom wall and more with the operating liquid located in the inner space of the operating liquid container.

Since the first electrode and the second electrode of the measuring capacitor are also embedded in the side wall of the operating liquid container, the influence of the material of the side wall on the capacitance of the measuring capacitor is reduced, and the influence of the operating liquid in the inner space of the operating liquid container on the capacitance of the measuring capacitor is increased. Therefore, the filling level of the operating liquid container can be determined with increased accuracy. Due to the embedding of the reference capacitor in the bottom wall, it is enclosed by the bottom wall. Due to the embedding of the measuring capacitor in the side wall, it is enclosed by the side wall.

A further advantage of embedding the reference capacitor in the bottom wall and the measuring capacitor in the side wall is that both the reference capacitor and the measuring capacitor are mechanically and chemically protected, so that the operating liquid container according to the invention has an increased long-term stability.

Further preferably, the operating liquid container is designed such that the side wall comprises an outer layer, an inner layer facing the inner space of the operating liquid container, and a bonding layer arranged in between, wherein the first electrode and the second electrode of the measuring capacitor are arranged between the outer layer and the bonding layer.

Therefore, the measuring capacitor is arranged between the outer layer and the bonding layer.

A corresponding design of the operating liquid container allows for a simplified structure and a simplified integration of the measuring capacitor in the side wall of the operating liquid container.

The inner layer can thus be brought into direct contact with the operating liquid.

Further preferably, the operating liquid container is designed such that the bottom wall comprises an outer layer, an inner layer facing the inner space of the operating liquid container, and a bonding layer arranged in between, wherein the first electrode and the second electrode of the reference capacitor are arranged between the outer layer and the bonding layer.

Therefore, the reference capacitor is arranged between the outer layer and the bonding layer.

A corresponding design of the operating liquid container allows for a simplified structure and a simplified integration of the reference capacitor in the bottom wall of the operating liquid container.

The inner layer can thus be brought into direct contact with the operating liquid.

Further preferably, the operating liquid container is designed such that the side wall and/or the bottom wall comprise a shielding layer and an insulating layer, wherein the shielding layer is arranged between the outer layer and the first and second electrodes, and wherein the insulating layer is arranged between the shielding layer and the first and second electrodes.

The correspondingly designed operating liquid container has the advantage that it has an additionally increased accuracy with regard to the determination of its filling level because the shielding layer, preferably designed as a metal layer, shields the electrodes of the reference capacitor from interfering fields.

The shielding layer is thus arranged between the outer layer and the reference capacitor or the measuring capacitor.

The shielding layer is preferably in contact with the outer layer.

Therefore, the insulating layer is arranged in a sandwich-like manner between the shielding layer and the reference capacitor or the measuring capacitor.

The shielding layer comprises a metal, so that the reference capacitor and/or the measuring capacitor is/are protected from interfering electrical fields.

The insulating layer is made from a dielectric material, preferably a plastic, so that the first and second electrodes of the measuring capacitor or the reference capacitor are not in electrical contact with the shielding layer.

Further preferably, the operating liquid container is designed such that the insulating layer has the same dielectric conductivity as the inner layer and/or the outer layer.

The correspondingly designed operating liquid container has the advantage that it has an additionally increased accuracy with regard to the determination of its filling level.

The same dielectric conductivity of the insulating layer as the dielectric conductivity of the inner layer and/or the outer layer refers essentially to the same dielectric conductivity. For example, the dielectric conductivity of the insulating layer is preferably between 90% and 110% of the dielectric conductivity of the inner layer and/or the outer layer.

Further preferably, the operating liquid container is designed such that a distance of the first and the second electrode to the inner space of the operating liquid container is between 1.5 mm and 3.5 mm.

The correspondingly designed operating liquid container has the advantage that it has an additionally increased accuracy with regard to the determination of its filling level because the distance of the respective electrodes to the operating liquid located in the inner space of the operating liquid container is reduced, so that the capacitance/capacitances of the reference capacitor and/or the measuring capacitor is/are determined less by the dielectric conductivity of the bottom wall or the side wall and more by the dielectric conductivity of the operating liquid.

Preferably, the inner layer thus has a thickness from 1.5 mm to 3.5 mm.

Therefore, the distance between the measuring capacitor and/or the reference capacitor to the inner space of the operating liquid container is only 1.5 mm to 3.5 mm.

Further preferably, the operating liquid container is designed such that at least one of the first and second electrodes of the measuring capacitor has a width extension which increases along its length extension in the direction of the bottom wall.

The correspondingly designed operating liquid container has the advantage that the measurement accuracy of the filling level is increased by means of the measuring capacitor in the bottom area of the operating liquid container.

Further preferably, the operating liquid container is designed such that the operating liquid container has a plurality of measuring capacitors which are fastened to a side wall or to a plurality of side walls.

The correspondingly designed operating liquid container has the advantage that its filling level can be determined with high accuracy even in case of an uneven or craggy geometry of the operating liquid container.

In the following, further advantages, details, and features of the invention shall become apparent from the described embodiments. The drawings show in detail in:

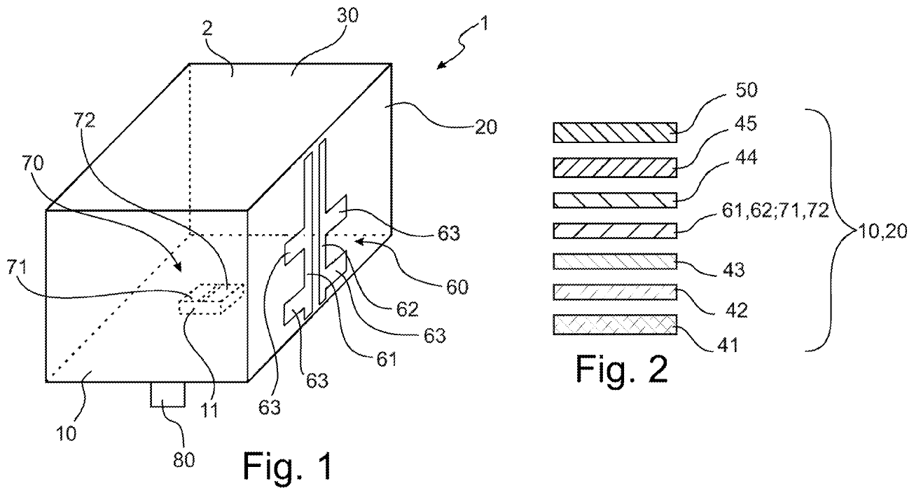

FIG. 1: A greatly simplified spatial depiction of an operating liquid container according to the invention;

FIG. 2: A greatly simplified depiction of a layer structure of the bottom wall and/or the side wall of the operating liquid container according to a further embodiment of the present invention; and

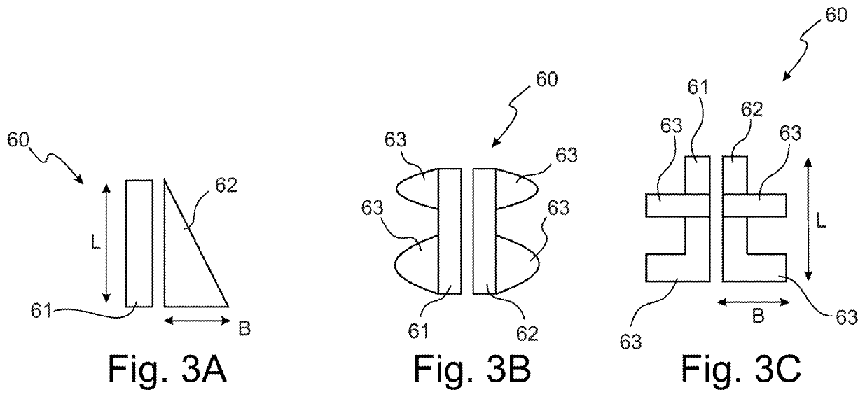

FIGS. 3A to 3C: A lateral top view of examples of measuring capacitors in isolation of operating liquid containers with different embodiments of the present invention.

In the following description, the same reference signs denote the same components or the same features, and so a description regarding a component with reference to a drawing also applies to the other drawings, so that a repetitious description is avoided. In addition, individual features described in connection with an embodiment can also be used separately in other embodiments.

FIG. 1 shows a greatly simplified spatial depiction of an operating liquid container 1 according to the invention. An inner space 2 of the operating liquid container is defined by a covering wall 30, a bottom wall 10, and a side wall 20 which connects the bottom wall 10 to the covering wall 30. FIG. 1 shows that the side wall 20 is designed so as to be continuous.

The operating liquid container 1 according to the invention has a reference capacitor 70 which comprises a first electrode 71 and a second electrode 72. The first electrode 71 and the second electrode 72 run parallel to the bottom wall 10.

As can be seen in FIG. 1, the bottom wall 10 has an elevation 11 which extends into the inner space 2 of the operating liquid container. The reference capacitor 70 is embedded in the bottom wall 10 such that the first electrode 71 and the second electrode 72 of the reference capacitor 70 are embedded in the elevation 11 of the bottom wall 10. As a result, the first electrode 71 and the second electrode 72 of the reference capacitor 70 are not in direct contact with the operating liquid 50. In addition, the first electrode 71 and the second electrode 72 of the reference capacitor 70 are also not in direct contact with the surroundings of the operating liquid container 1. Due to the embedding of the first electrode 71 and the second electrode 72 in the elevation 11 of the bottom wall 10, possible deposits on the bottom wall 10 have a diminished effect on determining the dielectric conductivity of the operating liquid 50 located in the inner space 2 of the operating liquid container.

With regard to embedding the reference capacitor 70 in the bottom wall 10 or in the elevation 11 in the bottom wall 10, reference is made to FIG. 2 which will be described below.

FIG. 1 further shows that the operating liquid container 1 according to the invention also has a measuring capacitor 60 which also comprises a first electrode 61 and a second electrode 62. Both the first electrode 61 and the second electrode 62 each have a length extension L, a width extension B, and a depth extension (see FIGS. 3A to 3C). In this case, the first electrode 61 and the second electrode 62 are each arranged parallel to the side wall 20 such that the length extensions L of the first electrode 61 and the second electrode 62 run from the bottom wall 10 in the direction of the covering wall 30.

The measuring capacitor 60 is embedded in the side wall 20, so that the first electrode 61 and the second electrode 62 of the measuring capacitor 70 are embedded in the side wall 20. As a result, the first electrode 61 and the second electrode 62 of the measuring capacitor 60 are not in direct contact with the operating liquid 50. In addition, the first electrode 61 and the second electrode 62 of the measuring capacitor 60 are also not in direct contact with the surroundings of the operating liquid container 1. With regard to the embedding of the measuring capacitor 60 in the side wall 20, reference is made to FIG. 2 which will be described below.

However, the present invention is not limited to the measuring capacitor 60 being embedded in the side wall 20 and the reference capacitor 70 being embedded in the bottom wall 10. The measuring capacitor 60 can also be fastened to an outer face of the side wall 20. In addition, the reference capacitor 70 can be fastened to an outer face of the bottom wall 10.

FIG. 1 shows that the first electrode 61 and the second electrode 62 of the measuring capacitor 60 each have two wings 63 which run parallel to the width extension B of the electrodes 61, 62. In this case, the respective wings 63 are designed to be at different heights of the first and second electrodes 61, 62, so that the wings 63 are arranged at different heights of the operating liquid container 1. Therefore, the first and second electrodes 61, 62 of the measuring capacitor 60 have an uneven width extension B along their longitudinal extension L. However, the present invention is not limited to a corresponding design of the first and second electrodes 61, 62 of the measuring capacitor 60. For example, the first and second electrodes 61, 62 of the measuring capacitor 60 can also have an even width extension B along their longitudinal extensions L.

The operating liquid container 1 further has an electronic evaluation device 80 which is electrically connected to the reference capacitor 70 and the measuring capacitor 60. The evaluation device 80 is connected to the reference capacitor 70 and the measuring capacitor 60 via electric lines not depicted in FIG. 1.

The evaluation device 80 is designed to apply an alternating voltage to the first electrode 61 of the measuring capacitor 60, and to determine the filling level of the operating liquid container 1 from the determined capacitance of the measuring capacitor 60. The capacitance of the measuring capacitor 60 depends on said capacitor's geometry, its dimensions, and the dielectric conductivity of the medium, in which the electric field is applied between the first electrode 61 and the second electrode 62. Since the dielectric conductivity of the operating liquid is determined by means of the reference capacitor 70, the filling level of the operating liquid container 1 can be determined via the capacitance of the measuring capacitor 60.

Since the capacitance of the reference capacitor 70 also depends on the dielectric conductivity of the operating liquid 50 in the inner space 2 of the operating liquid container, the evaluation device 80 is designed to determine the dielectric conductivity of the operating liquid by means of the reference capacitor 70.

FIG. 2 shows a greatly simplified depiction of a layer structure of the bottom wall 10 and/or the side wall 20 of the operating liquid container 1. It can be seen that the bottom wall 10 and/or the side wall 20 has/have a multilayered structure.

It can be seen that the bottom wall 10 comprises an outer layer 41, an inner layer 45 facing the inner space 2 of the operating liquid container, and a bonding layer 44 arranged between the outer layer 41 and the inner layer 45. The first electrode 71 and the second electrode 72 of the reference capacitor 70 are arranged between the outer layer 41 and the bonding layer 44. The bottom wall 10 furthermore has a shielding layer 42 and an insulating layer 43, wherein the shielding layer 42 is arranged between the outer layer 41 and the first and second electrodes 71, 72 of the reference capacitor 70. In turn, the insulating layer 43 is arranged between the shielding layer 42 and the first and second electrode 71, 72 of the reference capacitor 70.

It can also be seen that the side wall 20 comprises an outer layer 41, an inner layer 45 facing the inner space 2 of the operating liquid container, and a bonding layer 44 arranged between the outer layer 41 and the inner layer 45. The first electrode 61 and the second electrode 62 of the measuring capacitor 60 are arranged between the outer layer 41 and the bonding layer 44. The side wall 20 further comprises a shielding layer 42 and an insulating layer 43, wherein the shielding layer 42 is arranged between the outer layer 41 and the first and second electrodes 61, 62 of the measuring capacitor 60. In turn, the insulating layer 43 is arranged between the shielding layer 42 and the first and second electrodes 61, 62 of the measuring capacitor 60.

FIG. 3A shows a lateral top view of a measuring capacitor 60 in isolation. In the depicted embodiment, it can be seen that the first electrode 61 of the measuring capacitor 60 has an even width extension B along its longitudinal extension L. By contrast, the second electrode 62 of the measuring capacitor 60 has a width extension B which is altered along the longitudinal extension of the second electrode 62. It can be seen that the width of the second electrode 62 has an increasing width extension B along its longitudinal extension L in the direction of the bottom wall 10.

FIG. 3B shows a further example of a measuring capacitor 60 according to a further embodiment of the operating liquid container 1. It can be seen that both the first electrode 61 and the second electrode 62 each have two wings 63 at different heights, i.e., in different positions with regard to the longitudinal extension L of the first and second electrodes 61, 62, said wings extending along the width extension B of the first and second electrodes 61, 62. It can be seen that the respective wings 63 are rounded.

FIG. 3C also shows a measuring capacitor 60 of an operating liquid container 1 according to a further embodiment. The measuring capacitor 60 shown in FIG. 3C is also designed such that both the first electrode 61 and the second electrode 62 each have two wings 63 which extend in the width extension B of the corresponding electrodes 61, 62. In this case, the respective wings 63 are arranged at different heights of the corresponding electrodes 61, 62.

However, the present invention is not limited to the embodiments of the measuring capacitor 60 shown in FIGS. 3A to 3C, as long as an electric field is generated by means of the measuring capacitor 60, which extends into the inner space 2 of the operating liquid container, so that the dielectric conductivity of the operating liquid 50 can be determined by means of the evaluation device 80.

### LIST OF REFERENCE SIGNS

1 Operating liquid container

2 Inner space of the operating liquid container

10 Bottom wall (of the operating liquid container)

11 Elevation (of the bottom wall)

20 Side wall (of the operating liquid container)

30 Covering wall

41 Outer layer (of the bottom wall/the side wall)

42 Shielding layer (of the bottom wall/the side wall)

43 Insulating layer (of the bottom wall/the side wall)

44 Bonding layer (of the bottom wall/the side wall)

45 Inner layer (of the bottom wall/the side wall)

50 Operating liquid

60 Measuring capacitor

61 First electrode (of the measuring capacitor)/first measuring electrode

62 Second electrode (of the measuring capacitor)/second measuring electrode

63 Wings (of the first electrode and/or the second electrode)

70 Reference capacitor

71 First electrode (of the reference capacitor)/first reference electrode

72 Second electrode (of the reference capacitor)/second reference electrode

80 Evaluation device

L Length extension (of the electrodes of the measuring capacitor)

B Width extension (of the electrodes of the measuring capacitor)

1. Operating liquid container (1), the inner space (2) of which is defined by a covering wall (30), a bottom wall (10) and a side wall (20) connecting the bottom wall (10) to the covering wall (30), comprising:
a reference capacitor (70) comprising a first electrode (71) and a second electrode (72), which both extend parallel to the bottom wall (10);
a measuring capacitor (60) comprising a first electrode (61) and a second electrode (62), which both have a length extension (L), a width extension (B) and a depth extension, and both extend parallel to the side wall (20) in such a way that the length extensions (L) of the first electrode (61) and the second electrode (62) extend from the bottom wall (10) towards the covering wall (30);
an evaluation device (80) electrically connecting to the reference capacitor (70) and the measuring capacitor (60), for determining a filling level of the operating liquid container (1) by means of measuring signals determined by the reference capacitor (70) and the measuring capacitor (60),
wherein the operating liquid container (1) is characterized by the following features:
the first electrode (71) and the second electrode (72) of the reference capacitor (70) are embedded in the bottom wall (10); and
the first electrode (61) and the second electrode (62) of the measuring capacitor (60) are embedded in the side wall (20).

2. Operating liquid container (1) according to claim 1, characterized by the following features:
the bottom wall (10) has an elevation (11) which extends into the inner space (2) of the operating liquid container; and
the first electrode (71) and the second electrode (72) of the measuring capacitor (70) are embedded in the elevation (11).

3. Operating liquid container (1) according to one of the previous claims, characterized by the following feature:
at least one of the first and second electrodes (61, 62) of the measuring capacitor (60) has an uneven width extension (B) along its length extension (L).

4. Operating liquid container (1), the inner space (2) of which is defined by a covering wall (30), a bottom wall (10) and a side wall (20) connecting the bottom wall (10) to the covering wall (30), comprising:
a reference capacitor (70) comprising a first electrode (71) and a second electrode (72), which both extend parallel to the bottom wall (10);
a measuring capacitor (60) comprising a first electrode (61) and a second electrode (62), which both have a length extension (L), a width extension (B) and a depth extension, and both extend parallel to the side wall (20) in such a way that the length extensions (L) of the first electrode (61) and the second electrode (62) extend from the bottom wall (10) towards the covering wall (30);
an evaluation device (80) electrically connecting to the reference capacitor (70) and the measuring capacitor (60), for determining a filling level of the operating liquid container (1) by means of measuring signals determined by the reference capacitor (70) and the measuring capacitor (60),
wherein the operating liquid container (1) is characterized by the following features:
the bottom wall (10) has an elevation (11) which extends into the inner space (2) of the operating liquid container; and
the first electrode (71) and the second electrode (72) of the reference capacitor (70) are fastened to the bottom wall (10) in the area of its elevation (11).

5. Operating liquid container (1) according to claim 4, characterized by the following feature:
at least one of the first and second electrodes (61, 62) of the measuring capacitor (60) has an uneven width extension (B) along its length extension (L).

6. Operating liquid container (1) according to claim 4 or 5, characterized by the following features:
the first electrode (71) and the second electrode (72) of the reference capacitor (70) are embedded in the bottom wall (10); and
the first electrode (61) and the second electrode (62) of the measuring capacitor (60) are embedded in the side wall (20).

7. Operating liquid container (1), the inner space (2) of which is defined by a covering wall (30), a bottom wall (10) and a side wall (20) connecting the bottom wall (10) to the covering wall (30), comprising:
a reference capacitor (70) comprising a first electrode (71) and a second electrode (72), which both extend parallel to the bottom wall (10);
a measuring capacitor (60) comprising a first electrode (61) and a second electrode (62), which both have a length extension (L), a width extension (B) and a depth extension, and both extend parallel to the side wall (20) in such a way that the length extensions (L) of the first electrode (61) and the second electrode (62) extend from the bottom wall (10) towards the covering wall (30);
an evaluation device (80) electrically connecting to the reference capacitor (70) and the measuring capacitor (60), for determining a filling level of the operating liquid container (1) by means of measuring signals determined by the reference capacitor (70) and the measuring capacitor (60),
wherein the operating liquid container (1) is characterized by the following feature:
at least one of the first and second electrodes (61, 62) of the measuring capacitor (60) has an uneven width extension (B) along its length extension (L).

8. Operating liquid container (1) according to claim 7, characterized by the following features:
the bottom wall (10) has an elevation (11) which extends into the inner space (2) of the operating liquid container; and
the first electrode (71) and the second electrode (72) of the reference capacitor (70) are fastened to the bottom wall (10) in the area of its elevation (11).

9. Operating liquid container (1) according to claim 7 or 8, characterized by the following features:
the first electrode (71) and the second electrode (72) of the reference capacitor (70) are embedded in the bottom wall (10); and
the first electrode (61) and the second electrode (62) of the measuring capacitor (60) are embedded in the side wall (20).

10. Operating liquid container (1) according to one of claim 1, 2, 3, 6, or 9, characterized by the following features:
the side wall (20) comprises an outer layer (41), an inner layer (45) facing the inner space (2) of the operating liquid container, and a bonding layer (44) arranged in between;
the first electrode (61) and the second electrode (62) of the measuring capacitor (60) are arranged between the outer layer (41) and the bonding layer (44).

11. Operating liquid container (1) according to one of claim 1, 2, 3, 6, or 9, characterized by the following features:
the bottom wall (10) comprises an outer layer (41), an inner layer (45) facing the inner space (2) of the operating liquid container, and a bonding layer (44) arranged in between;
the first electrode (71) and the second electrode (72) of the reference capacitor (70) are arranged between the outer layer (41) and the bonding layer (44).

12. Operating liquid container (1) according to claim 10 or 11, characterized in that
the side wall (20) and/or the bottom wall (10) comprise a shielding layer (42) and an insulating layer (43);
the shielding layer (42) is arranged between the outer layer (41) and the first and second electrodes (61, 62; 71, 72); and
the insulating layer (43) is arranged between the shielding layer (42) and the first and second electrodes (61, 62; 71, 72).

13. Operating liquid container (1) according to claim 12, characterized in that the insulating layer (43) has the same dielectric conductivity as the inner layer (45) and/or the outer layer (41).

14. Operating liquid container (1) according to one of the previous claims, characterized in that a distance of the first and second electrodes (61, 62; 71, 72) to the inner space of the operating liquid container is between 1.5 mm and 3.5 mm.

15. Operating liquid container (1) according to one of the previous claims, characterized in that at least one of the first and second electrodes (61, 62) of the measuring capacitor (60) has a width extension (B) which increases along its length extension (L) in the direction of the bottom wall (10).

16. Operating liquid container (1) according to one of the previous claims, characterized in that the operating liquid container (1) has a plurality of measuring capacitors (60) which are fastened to a side wall (20) or to a plurality of side walls (20).
